(19) United States
(12) Patent Application Publication
(10) Pub. No.: US 2014/0254888 A1
(43) Pub. Date: Sep. 11, 2014

(54) METHOD AND APPARATUS FOR ENCODING ASSISTANCE DATA IN LOCATION TECHNOLOGIES

(71) Applicant: QUALCOMM INCORPORATED, San Diego, CA (US)

(72) Inventors: Liang-Yun Wang, San Diego, CA (US); Ashok Bhatia, San Diego, CA (US); Weihua Gao, San Jose, CA (US)

(73) Assignee: QUALCOMM Incorporated, San Diego, CA (US)

(21) Appl. No.: 13/788,379

(22) Filed: Mar. 7, 2013

(51) Int. Cl. G06T 9/00

(52) U.S. Cl. CPC G06T 9/00
USPC 382/113

(57) ABSTRACT

Systems, apparatus, and methods according to one or more embodiments are provided for encoding assistance data in locations technologies. In an embodiment, a method includes reading, by a processor, tile data of a database in a specific order, wherein the tile data comprises one or more reference data points and/or one or more empty spaces. The method also includes compressing, by the processor, the tile data based on the specific order using encoding. And the method further includes generating relative positions for each individual reference data point with respect to each other in the compressed tile data without specific location identification information for each reference data point.

### BACKGROUND

I. Field of the Invention

The present disclosure generally relates to data encoding, and more particularly, to encoding of assistance data in location technologies.

II. Background

Generally, common wireless-based positioning techniques such as global map positioning techniques may require at least some location information of individual access points. A user device (e.g., a mobile device such as a smart phone, a tablet, a cellular phone, etc.) may first scan an environment and use measurement results (e.g., access point signal strength or scan range between the user device and an access point) coupled with known locations of individual access points, to determine its own location.

An “online” system may store a database, for example a global map, at a server side while an “offline” system may store all or part of the database at the user devices. The database (e.g., the global map) may include or be divided into pieces (also referred to as “tiles”).

Because the database is usually very large, for example a few Gigabytes (and growing) for a global map, user devices may have to download pieces or tiles of database from the server and store those pieces or tiles temporarily. When downloaded tiles are large in size, there may be uncertainty in locations of access points and potentially inadequate range of signal detection.

Currently, generic normal lossless data compression algorithms (e.g., ZIP) may be applied to potentially reduce the size of downloaded database tiles. In addition, exclusion of some access points has been considered to exchange tile size for potential positioning performance.

However, generic data compression algorithms may not be optimum for certain applications that may require better certainty of AP locations thus giving rather limited results. Also, exclusion of a significant amount of access points may not be optimum because the exclusion may not only impact positioning performance, but also may consume extra server-side computation power to analyze what access points may be removed to reduce the impact.

### SUMMARY

According to one or more embodiments of the present disclosure, methods and systems are provided for encoding assistance data in location technologies. In various embodiments, the tile size of a database may be efficiently reduced in order to improve location technologies.

In an embodiment, a method includes reading, by a processor, tile data of a database in a specific order, wherein the tile data comprises one or more reference data points and/or one or more empty spaces (i.e., at least one reference data point, at least one empty space, or both at least one reference data point and at least one empty space). The method also includes compressing, by the processor, the tile data based on the specific order using encoding to form compressed tile data. And the method further includes generating relative positions for each individual reference data point with respect to each other in the compressed tile data without specific location identification information for each reference data point.

In another embodiment, a user device comprises one or more processors, and one or more memories adapted to store a plurality of machine-readable instructions which when executed by the one or more processors are adapted to cause the user device to read tile data of a database in a specific order, wherein the tile data comprises one or more reference data points and/or one or more empty spaces. The plurality of machine-readable instructions is further adapted to cause the user device to compress the tile data based on the specific order using encoding to form compressed tile data. And the plurality of machine-readable instructions is further adapted to cause the user device to generate relative positions for each individual reference data point with respect to each other in the compressed tile data without specific location identification information for each reference data point.

In a further embodiment, a non-transitory computer readable medium on which are stored computer readable instructions and, when executed by a processor, cause the processor to read tile data of a database in a specific order, wherein the tile data comprises one or more reference data points and/or one or more empty spaces. The instructions, when executed by the processor, further cause the processor to compress the tile data based on the specific order using encoding to form compressed tile data. And the instructions, when executed by the processor, further cause the processor to generate relative positions for each individual reference data point with respect to each other in the compressed tile data without specific location identification information for each reference data point.

In yet another embodiment, an apparatus comprises means for reading tile data of a database in a specific order, wherein the tile data comprises one or more reference data points and/or one or more empty spaces. The apparatus also comprises means for compressing the tile data based on the specific order using means for encoding to form compressed tile data. And the apparatus further comprises means for generating relative positions for each individual reference data point with respect to each other in the compressed tile data without specific location identification information for each reference data point.

### BRIEF DESCRIPTION OF THE DRAWINGS

FIG. 1 is a diagram illustrating tiles of a map according to an embodiment of the present disclosure.

FIG. 2 is a flow diagram illustrating a method for encoding of assistance data in location technologies according to an embodiment of the present disclosure.

FIG. 3 is a diagram illustrating tile compression according to an embodiment of the present disclosure.

FIG. 4 is a diagram illustrating tile compression according to another embodiment of the present disclosure.

FIG. 5 is a diagram illustrating location identification information of an access point according to an embodiment of the present disclosure.

FIG. 6 is a block diagram of a system for implementing a device according to an embodiment of the present disclosure.

Like element numbers in different figures represent the same or similar elements.

### DETAILED DESCRIPTION

Systems and methods according to one or more embodiments of the present disclosure are provided for encoding of assistance data in location technologies. In various embodiments, the tile size of a database may be efficiently reduced in order to improve location technologies.

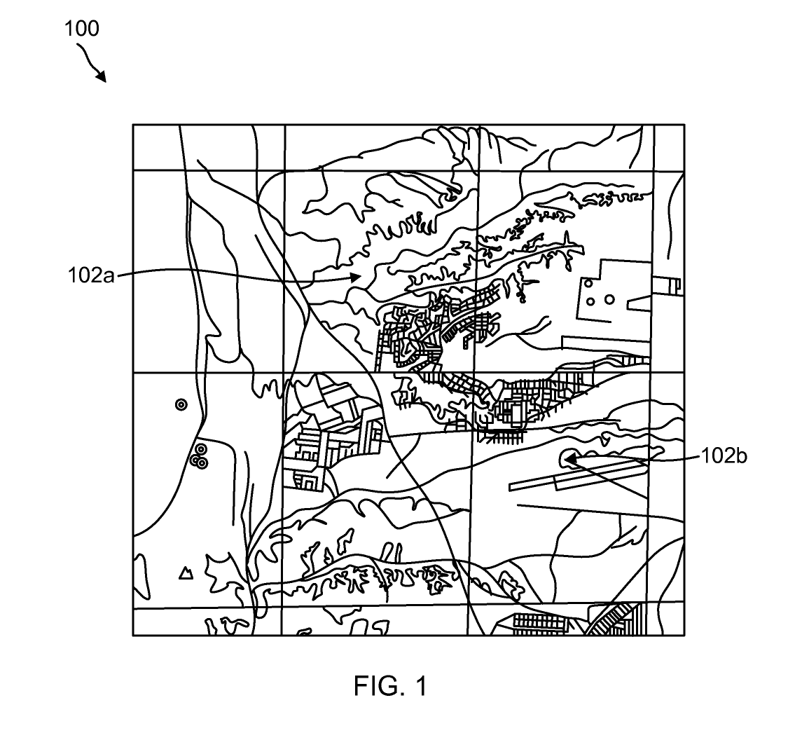

A tile generally refers to a small piece of a database (e.g., a global map). For example, FIG. 1 shows illustrative tiles including tiles 102a and 102b in a map 100. The global map in this example may be divided into a square grid where the size of each tile may be about the same size.

The global map may include information for all known Access Points (AP) in the world. The file size of a tile may be determined by how many APs are in an area or zone. For example, a tile may include only one AP in less populated areas.

Large databases such as all or part of the global map may be downloaded and stored in user devices (e.g., a mobile device such as a smart phone, a tablet, a cellular phone, etc.). Because a database may be very large, user devices may have to download pieces or tiles of the database from a server and store those pieces or tiles temporarily. It should be noted that databases may include any appropriate database having reference data points. For example, a database may be an Access Point database having access points, a street address database having street addresses, a Femto cells database, a wireless communication (e.g., Bluetooth) receiver database, or any other database having appropriate data points.

According to one or more embodiments of the present disclosure, tile compression may be used, that is, the size of downloaded tiles may be compressed. Tile compression is important because, for instance, smaller tiles may be generally downloaded faster on a user device and may require lower operating expenses for bandwidth at a server side as well as at the user device. Furthermore, tile compression may be important because when tiles are compressed, more tiles may be downloaded with more access points for a given cache size thus improving performance of the user device and saving costs.

In an embodiment, tile format such as tile size for a given area may appear on user devices with known data to determine the location of access points (AP). Such known data may include AP information (including for example, MAC addresses), latitude and longitude, and maximum detection range (e.g., 300 meters, 1000 feet, or any appropriate range) of access points at the given area.

A tile, which may include many access points, may be described by location identification information including, for example:

AP 1—AP1 information, Latitude, Longitude, Maximum detection range;

AP 2—AP2 information, Latitude, Longitude, Maximum detection range; . . .

AP n—APn information, Latitude, Longitude, Maximum detection range.

AP information may include a MAC address, which may correspond to a globally unique identifier (e.g. a hardware vendor identifier plus a serial number within the hardware vendor) for each access point. In current tile formats as used, for example, in WiFi networks, access points may be included where each access point may require 9 bytes of memory. In such formats, a sorted MAC address section that may be loaded into a user device's memory as an index section may take 6 bytes, for example. In addition to these 6 bytes, a detailed AP information section (all data pre-shifted/quantized/encoded) may include latitude, longitude, and maximum detection range, which may require 1 byte each. As such, each access point requires 6+1+1+1=9 bytes of memory for storage of current tile format files. It should be noted that the detailed AP information section may only be looked up when there is a “hit” in a WiFi scan.

According to one or more embodiments of the present disclosure, there may not be a need to store any location identification information for each access point. In embodiments herein, location information for each individual access point may be embedded without explicitly specifying actual location identification information such as latitude, longitude, direction (e.g., north and east), altitude, or any other form of location identification information. In embodiments herein, the known data may indicate that individual access points (or a group of access points) may not have actual location identification information such as latitude, longitude or other location identification information.

Instead, in embodiments herein, location information may be conveyed in a relative manner. That is, only the relative or related location of APs in a tile may need to be stored, thus improving performance and saving costs.

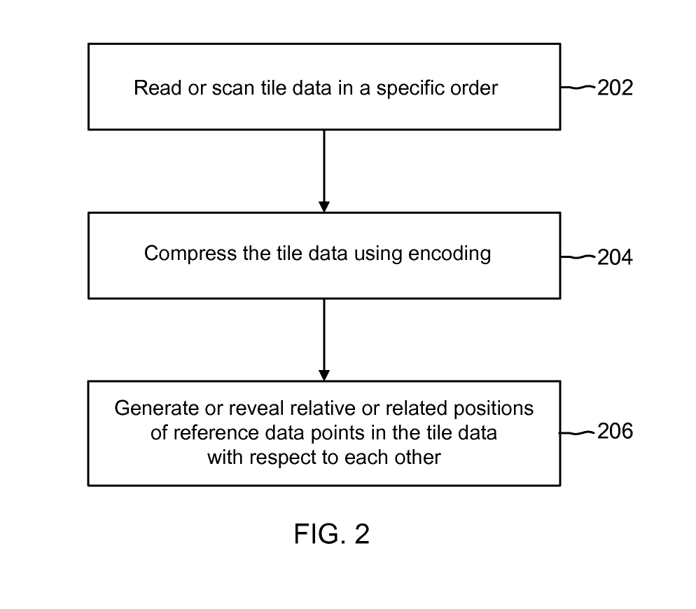

Referring to FIG. 2, a flow diagram illustrates a method for encoding of assistance data in location technologies according to an embodiment of the present disclosure. As set forth above, it should be noted that although embodiments herein may be described with respect to an Access Point (AP) database, embodiments of the present disclosure may apply to any database including, for example, a street address database having street addresses, a Femto cells database, a wireless communication (e.g., Bluetooth) receiver database, or any other database having appropriate reference data points.

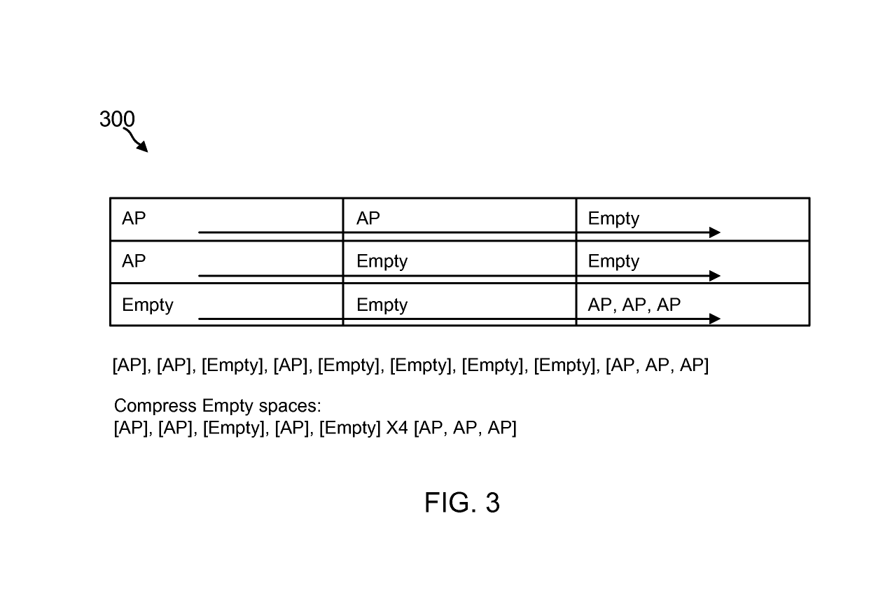

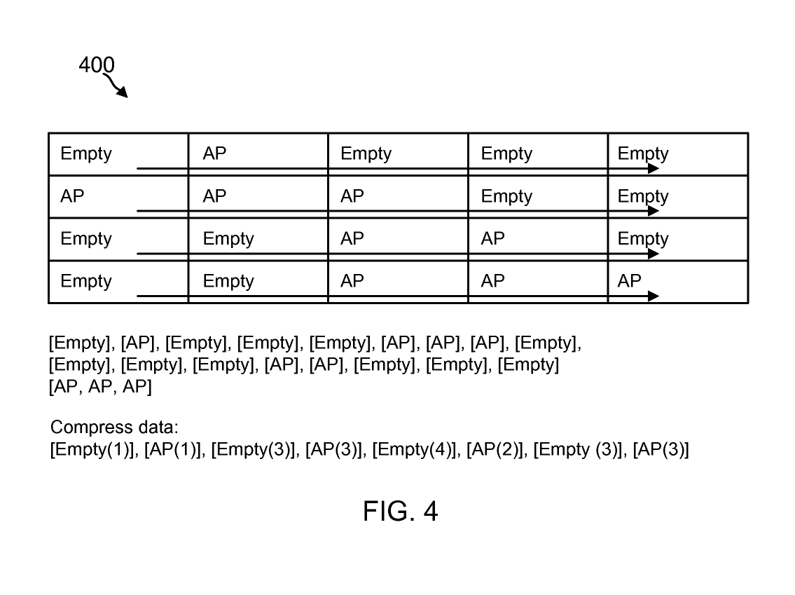

In block 202, tile data may be read or scanned in a specific order. Reading or scanning through tile data in a specific order, for example sequentially, may reveal a quantized related position of reference data points such as access points with respect to each other. Examples of reading or scanning through tile data in a specific order will be described in more detail below with respect to FIGS. 3 and 4.

In block 204, the tile data may be compressed using encoding. Examples of compressing tile data will also be described in more detail below with respect to FIGS. 3 and 4.

In block 206, relative or related positions of reference data points, e.g., access points, of the tile data with respect to each other may be generated or revealed. In that regard, relative or related positions for each individual reference data point with respect to each other in the compressed tile data may be generated without specific location identification information for each reference data point.

In various embodiments, the relative or related positions of access points of the tile data with respect to each other may be stored, but without the need to store location identification information (e.g., latitude and longitude) for the access points. Advantageously, tile data may be compressed as will be described in more detail below.

Referring now to FIG. 3, a diagram illustrates tile compression according to an embodiment of the present disclosure.

In FIG. 3, a table 300 representing a tile includes nine cells (3×3) where each cell is either empty or has one or more APs in relative positions to each other. In this embodiment, the sequential order of this tile is as follows (reading row by row in the direction indicated by the arrows):

[AP], [AP], [Empty], [AP], [Empty], [Empty], [Empty], [Empty], [AP, AP, AP].

Scanning table 300 row by row, contiguous empty spaces may be compressed using encoding such as Run Length Encoding, as follows:

[AP], [AP], [Empty], [AP], [Empty] X4 [AP, AP, AP].

As such, the tile size may be compressed or reduced. In an example for a WiFi network, the expected savings in tile size may be 22%, i.e., 2 empty spaces out of 9 were compressed (2/9=22%).

Referring now to FIG. 4, a diagram illustrates tile compression according to another embodiment of the present disclosure.

In FIG. 4, a table 400 representing a tile includes 20 cells (4×5) where each cell is either empty or has one or more APs in relative positions to each other. In this example, the sequential order of this tile is as follows (reading row by row in the direction indicated by the arrows):

[Empty], [AP], [Empty], [Empty], [Empty], [AP], [AP], [AP], [Empty], [Empty], [Empty], [Empty], [AP], [AP], [Empty], [Empty], [Empty], [AP], [AP], [AP].

Scanning tile 400 row by row, contiguous empty spaces and APs may be compressed using encoding such as Run Length Encoding, as follows:

[Empty(1)], [AP(1)], [Empty(3)], [AP(3)], [Empty(4)], [AP(2)], [Empty (3)], [AP(3)].

As such, the tile size may be compressed or reduced.

An exemplary analogy may be related to a bitmap used in computers. In a bitmap, X, Y coordinates are not carried for each pixel in the bitmap, but pixel data is ordered in a specific way. Reading through the data may reveal the relative or related location of the pixels, but not the absolute coordinate of each pixel. Similarly, as illustrated in FIGS. 3 and 4 described above according to one or more embodiments, typical X, Y coordinates of each cell may not be carried. Instead, cell data is ordered in a specific manner. Reading or scanning through the data reveals the relative or related location of the cells, but not necessarily the absolute coordinate of each cell.

In various embodiments, large tables of fixed dimensions (e.g. 256×256) may be created. The relative or related location of access points may be quantized and filled into the table. At this point, each cell of the table may be either empty or may include a certain number of access points. The table may then be scanned in an appropriate manner, for example, row by row as illustrated above. The table may also be stored into a file.

Because the relationship of location is described, according to one or more embodiments, by the order of observation, location information may not need to be stored specifically for each access point. There is minimal overhead to describe the matrix, that is, there are less cells to be described. As such, savings of about 20-22% of space for each access point may generally be achieved.

In examples of real world environments, the nature of distribution of access points may tend to show up along busy streets or big buildings. As such, for other less populated areas, a lot of empty spaces may show up in a table or map. As described above, one way to reduce the overhead of describing an empty cell is through Run Length Encoding. Instead of identifying a cell as “this cell is empty”, for example, the cell may be identified as “this cell and the following 60 cells are empty”.

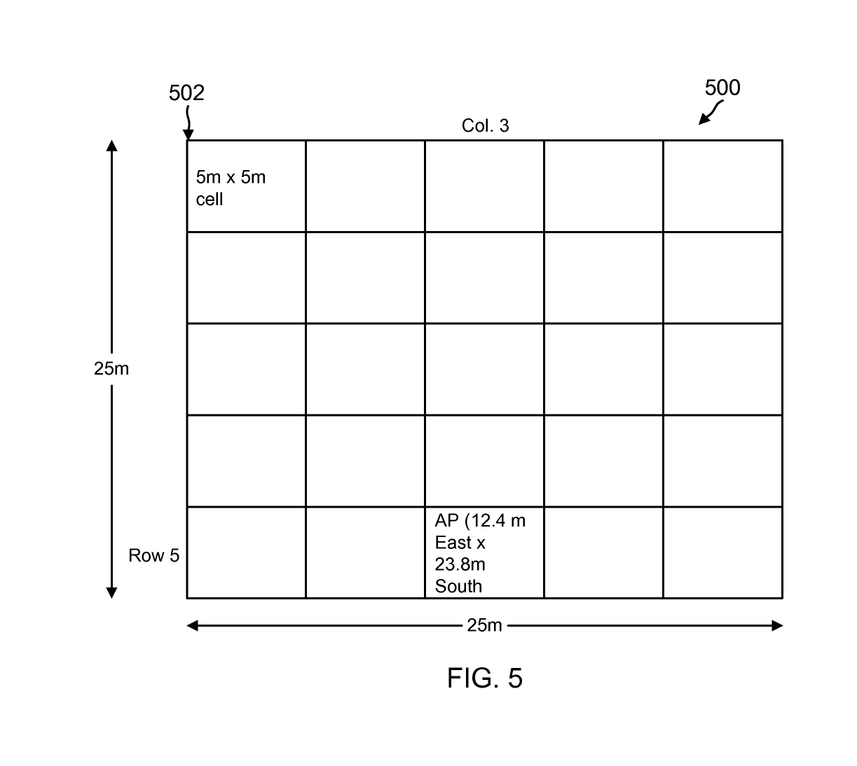

Referring now to FIG. 5, a diagram illustrates location identification information of an access point according to an embodiment of the present disclosure. In various embodiments, the origin of a map, for example, location identification information such as the latitude and longitude of a corner of a tile may be known so that each access point may be precisely located.

Relative location may be expressed as a quantized distance from a reference location (e.g., a corner of the tile). For example, in FIG. 5, a reference location 502 may be a left top corner of a tile 500, for which the absolute latitude/longitude of that location point is known. According to embodiments herein, a particular access point's distance from that reference location may be determined and then quantized. For example, tile data may include cells of a certain size, for instance, the cells in tile 500 may each be 5 m×5 m. If one access point is, for example, 12.47 m East and 23.58 m South in relation to the reference location 502 (left-top corner), the access point would be placed at the 3rd column (East) and 5th row (South).

In various embodiments, cells may be of any shape. For example, other than square shaped, cells may be rectangular or of any other appropriate shape.

Using the exemplary analogy of pixels in a bitmap used in computers, each ‘cell’ may be represented as a ‘pixel’. In some cases, quantizing the distance into ‘cells’ may lose accuracy, but it may greatly improve compression of the overall data or information. When the data is ‘decompressed’, the access points may be assumed to be at the center, or at any corner, or anywhere in a cell. In one embodiment, an access point may be positioned at the center of the cell.

In an experiment where a tile for part of the city of Madrid was used, the savings in tile size resulted in a 20%-21% reduction due to minimal overhead to describe a representative matrix. In a tile for part of the city of Madrid, where there were approximately 200 thousand access points, most of the 200 thousand access points were found along main streets. In such a case where there may be a lot of surrounding empty spaces, Run Length Encoding of empty cells may prove to be very effective.

As described above, reading or scanning may be easily done row by row. However, it should be noted that other ways of reading or scanning may be used to achieve similar results, for example, column by column, in a zigzag, in micro tiles to better use the locality of empty spaces, or in any other appropriate way.

It should also be noted that forms of encoding other than Run Length Encoding may be used.

Advantageously, embodiments of the present disclosure provide significant tile size reduction without sacrificing the number of reference data point such as access points.

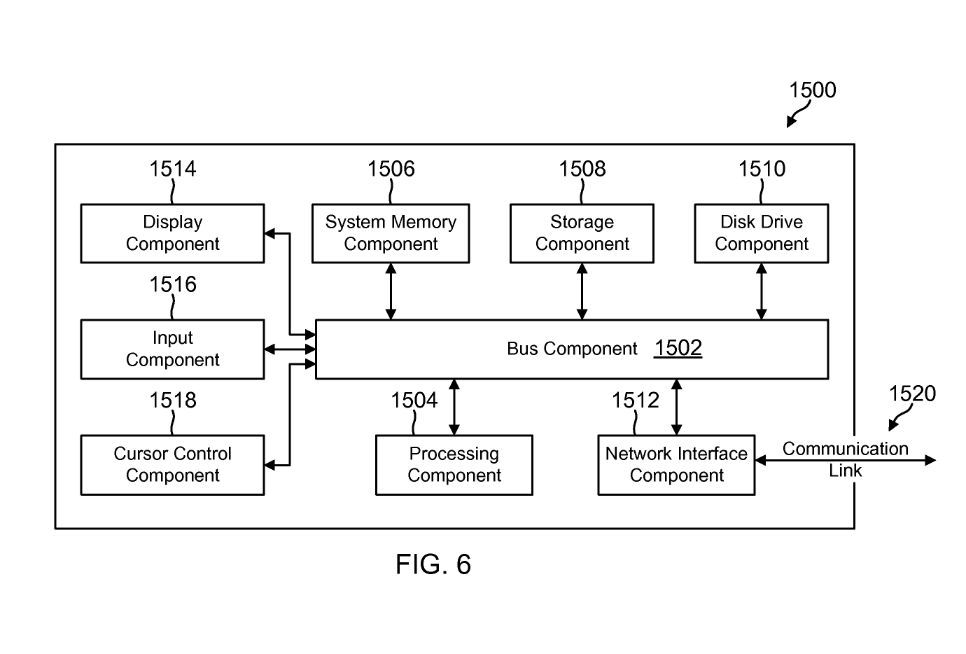

Referring now to FIG. 6, a block diagram of a system for implementing a device is illustrated according to an embodiment of the present disclosure.

It will be appreciated that the methods and systems disclosed herein may be implemented by or incorporated into a wide variety of electronic systems or devices. For example, a system 1500 may be used to implement any type of device including wired or wireless devices such as a mobile device, a smart phone, a Personal Digital Assistant (PDA), a tablet, a laptop, a personal computer, a TV, or the like. Other exemplary electronic systems such as a music player, a video player, a communication device, a network server, etc. may also be configured in accordance with the disclosure.

System 1500 may be suitable for implementing embodiments of the present disclosure, including user devices that may display, for example, part of a database such as a global map as illustrated in FIG. 1. System 1500, such as part of a device, e.g., smart phone, tablet, personal computer and/or a network server, includes a bus 1502 or other communication mechanism for communicating information, which interconnects subsystems and components, including one or more of a processing component 1504 (e.g., processor, micro-controller, digital signal processor (DSP), etc.), a system memory component 1506 (e.g., RAM), a static storage component 1508 (e.g., ROM), a network interface component 1512, a display component 1514 (or alternatively, an interface to an external display), an input component 1516 (e.g., keypad or keyboard, touch screen, etc.), and a cursor control component 1518 (e.g., a mouse pad).

In accordance with embodiments of the present disclosure, system 1500 performs specific operations by processing component 1504 executing one or more sequences of one or more instructions contained in system memory component 1506. Such instructions may be read into system memory component 1506 from another computer readable medium, such as static storage component 1508. These may include instructions to encode assistance data in location technologies. In other embodiments, hard-wired circuitry may be used in place of or in combination with software instructions for implementation of one or more embodiments of the disclosure.

Logic may be encoded in a computer readable medium, which may refer to any medium that participates in providing instructions to processing component 1504 for execution. Such a medium may take many forms, including but not limited to, non-volatile media, volatile media, and transmission media. In various implementations, volatile media includes dynamic memory, such as system memory component 1506, and transmission media includes coaxial cables, copper wire, and fiber optics, including wires that comprise bus 1502. In an embodiment, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read. The computer readable medium may be non-transitory.

In various embodiments of the disclosure, execution of instruction sequences to practice the disclosure may be performed by system 1500. In various other embodiments, a plurality of systems 1500 coupled by communication link 1520 (e.g., WiFi, or various other wired or wireless networks) may perform instruction sequences to practice the disclosure in coordination with one another. System 1500 may display data, for example, part of a database or a global map, via display component 1514. Also, system 1500 may encode assistance data in location technologies such that the tile size of a database may be efficiently reduced in order to improve location technologies. System 1500 may transmit and receive data as well as beacons, messages, information and instructions, including one or more programs (i.e., application code) through communication link 1520 and network interface component 1512. Received program code may be executed by processing component 1504 as received and/or stored in disk drive component 1510 or some other non-volatile storage component for execution.

System 1500 may communicate via one or more wireless communication links (e.g., communication link 1520) that are based on or otherwise support any suitable wireless communications technology. For example, in some aspects, a user device may associate with a network. In some aspects the network may comprise a body area network or a personal area network. In some aspects the network may comprise a local area network or a wide area network. A user device may support or otherwise use one or more of a variety of wireless communications technologies, protocols, or standards such as, for example, CDMA, TDMA, OFDM, OFDMA, WiMAX, and WiFi. Similarly, a user device may support or otherwise use one or more of a variety of corresponding modulation or multiplexing schemes. A user device may thus include appropriate components (e.g., air interfaces) to establish and communicate via one or more wireless communications links using the above or other wireless communication technologies. For example, a user device may comprise a wireless transceiver with associated transmitter and receiver components that may include various components (e.g., signal generators and signal processors) that facilitate communication over a wireless medium.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method for encoding assistance data in location technologies comprising:
reading, by a processor, tile data of a database in a specific order, wherein the tile data comprises one or more reference data points and/or one or more empty spaces;
compressing, by the processor, the tile data based on the specific order using encoding to form compressed tile data; and
generating relative positions for each individual reference data point with respect to each other in the compressed tile data without specific location identification information for each reference data point.

2. The method of claim 1, wherein the compressing further comprises compressing contiguous reference data points or empty spaces as read in the specific order.

3. The method of claim 1, wherein the specific order further comprises a sequential order.

4. The method of claim 1, wherein the reading further comprises reading the tile data row by row, column by column, in a zigzag, or in micro tiles.

5. The method of claim 1, wherein the database further comprises an Access Point database, a street address database, a Femto cells database, or a wireless communication receiver database.

6. The method of claim 1, wherein the one or more reference data points further comprise Access Points, street addresses, Femto cells, or wireless communication receiver reference points.

7. The method of claim 1, wherein the location identification information further comprises latitude, longitude, altitude, or direction.

8. The method of claim 1, further comprising providing location identification information of an origin of a tile of the tile data such that each individual reference data point is precisely located.

9. The method of claim 8, wherein the location identification information of the origin of the tile of the tile data further comprises latitude, longitude or direction of a corner of the tile.

10. The method of claim 1, wherein the encoding further comprises Run Length Encoding.

11. The method of claim 1, further comprising downloading the tile data by a user device.

12. A user device comprising:
one or more processors; and
one or more memories adapted to store a plurality of machine-readable instructions which when executed by the one or more processors are adapted to cause the user device to:
read tile data of a database in a specific order, wherein the tile data comprises one or more reference data points and/or one or more empty spaces;
compress the tile data based on the specific order using encoding to form compressed tile data; and
generate relative positions for each individual reference data point with respect to each other in the compressed tile data without specific location identification information for each reference data point.

13. The user device of claim 12, further comprising a user interface adapted to display at least a portion of the database comprising the tile data.

14. The user device of claim 12, wherein the plurality of machine-readable instructions which when executed by the one or more processors are adapted to further cause the user device to compress contiguous reference data points or empty spaces as read in the specific order.

15. The user device of claim 12, wherein the plurality of machine-readable instructions which when executed by the one or more processors are adapted to further cause the user device to read the tile data in a sequential order, row by row, column by column, in a zigzag, or in micro tiles.

16. The user device of claim 12, wherein the database further comprises an Access Point database, a street address database, a Femto cells database, or a wireless communication receiver database.

17. The user device of claim 12, wherein the one or more reference data points further comprise Access Points, street addresses, Femto cells, or wireless communication receiver reference points.

18. The user device of claim 12, wherein the location identification information further comprises latitude, longitude, altitude, or direction.

19. The user device of claim 12, wherein the plurality of machine-readable instructions which when executed by the one or more processors are adapted to further cause the user device to identify location identification information of an origin of a tile of the tile data such that each individual reference data point is precisely located.

20. The user device of claim 19, wherein the location identification information of the origin of the tile of the tile data further comprises latitude, longitude or direction of a corner of the tile.

21. The user device of claim 12, wherein the encoding further comprises Run Length Encoding.

22. The user device of claim 12, further comprising a mobile device, a smart phone, a Personal Digital Assistant (PDA), a tablet, a laptop, a personal computer, or a TV.

23. A non-transitory computer readable medium on which are stored computer readable instructions and, when executed by a processor, cause the processor to:
read tile data of a database in a specific order, wherein the tile data comprises one or more reference data points and/or one or more empty spaces;
compress the tile data based on the specific order using encoding to form compressed tile data; and
generate relative positions for each individual reference data point with respect to each other in the compressed tile data without specific location identification information for each reference data point.

24. The non-transitory computer readable medium of claim 23, wherein the computer readable instructions which when executed by the processor, further cause the processor to compress contiguous reference data points or empty spaces as read in the specific order.

25. The non-transitory computer readable medium of claim 23, wherein the computer readable instructions which when executed by the processor, further cause the processor to read the tile data in a sequential order, row by row, column by column, in a zigzag, or in micro tiles.

26. An apparatus comprising:
means for reading tile data of a database in a specific order, wherein the tile data comprises one or more reference data points and/or one or more empty spaces;
means for compressing the tile data based on the specific order using means for encoding to form compressed tile data; and
means for generating relative positions for each individual reference data point with respect to each other in the compressed tile data without specific location identification information for each reference data point.

27. The apparatus of claim 26, wherein the means for compressing further comprises means for compressing contiguous reference data points or empty spaces as read in the specific order.

28. The apparatus of claim 26, wherein the specific order further comprises a sequential order.

29. The apparatus of claim 26, wherein the means for reading further comprises means for reading the tile data row by row, column by column, in a zigzag, or in micro tiles.

30. The apparatus of claim 26, wherein the database further comprises an Access Point database, a street address database, a Femto cells database, or a wireless communication receiver database.

31. The apparatus of claim 26, wherein the one or more reference data points further comprise Access Points, street addresses, Femto cells, or wireless communication receiver reference points.

32. The apparatus of claim 26, wherein the location identification information further comprises latitude, longitude, altitude, or direction.

33. The apparatus of claim 26, further comprising means for providing location identification information of an origin of a tile of the tile data such that each individual reference data point is precisely located.

34. The apparatus of claim 33, wherein the location identification information of the origin of the tile of the tile data further comprises latitude, longitude or direction of a corner of the tile.

35. The apparatus of claim 26, wherein the means for encoding comprises Run Length Encoding.

36. The apparatus of claim 26, further comprising means for downloading at least a portion of the database comprising the tile data.

37. The apparatus of claim 26, further comprising means for displaying at least a portion of the database comprising the tile data.
